(19) United States
(12) Patent Application Publication
(10) Pub. No.: US 2023/0099336 A1
(43) Pub. Date: Mar. 30, 2023

(54) SUPPORT DEVICE AND DISPLAY DEVICE

(71) Applicant: Panasonic Intellectual Property Management Co., Ltd., Osaka (JP)

(72) Inventor: Tomohiro SEKIGUCHI, Kanagawa (JP)

(21) Appl. No.: 17/900,469

(22) Filed: Aug. 31, 2022

(30) Foreign Application Priority Data
Sep. 27, 2021 (JP) 2021-156705

(51) Int. Cl. B60R 11/02; G06F 1/16

(52) U.S. Cl. CPC B60R 11/0235; G06F 1/1601; B60R 2011/0085

(57) ABSTRACT

A support device includes: a rear panel including a first surface attached to a back surface of a display, and a first coupling member fixedly attached to a second surface of the rear panel. The rear panel includes a base plate portion, a plurality of ribs, and a reinforcing member. The ribs are provided on a surface of the base plate portion corresponding to the first surface. Each of the ribs has a plate shape perpendicularly rising from a surface of the base plate portion and has a same height from the surface of the base plate portion. The ribs provide spaces between the back surface of the display and the base plate portion. The reinforcing member is provided in one or more of the spaces to reinforce the base plate portion. The one or more spaces are located at a position corresponding to the first coupling member.

### CROSS-REFERENCE TO RELATED APPLICATIONS

This application is based upon and claims the benefit of priority from Japanese Patent Application No. 2021-156705, filed on Sep. 27, 2021, the entire contents of which are incorporated herein by reference.

### FIELD

The present disclosure relates generally to a support device and a display device.

### BACKGROUND

There is a known display device that is attached to a front seat in a vehicle interior of a vehicle to provide images to a passenger sitting on a rear seat. Such a display device is attached to the front seat through, for example, a coupling member provided on the back surface. In addition, in such a display device, the coupling member is rotatable by using a hinge or the like in a manner that the display surface can be adjusted at an appropriate angle regardless of the angle of the backrest of the front seat.

Such a display device is attached to a seat, so that it is desirable to reduce the weight. As a related art, a notebook computer, which has a honeycomb structure on the back side of a display to reduce the weight of the display, is disclosed (for example, JP 2011-008356 A).

Such a display device is, however, required to have sufficient strength which does not to cause breakage or the like when an external impact is applied, while attempting to reduce the weight.

### SUMMARY

A support device according to the present disclosure includes a rear panel and a first coupling member. The rear panel includes a first surface attached to a back surface of a display to support the display from the back surface. The first coupling member is fixedly attached to a second surface of the rear panel opposite to the first surface. The rear panel includes a base plate portion, a plurality of ribs, and a reinforcing member. The base plate portion has a flat plate shape. The plurality of ribs is provided on a surface of the base plate portion corresponding to the first surface of the rear panel. Each rib has a plate shape perpendicularly rising from a surface of the base plate portion and having a same height from the surface of the base plate portion. The plurality of ribs is configured to provide a plurality of spaces between the back surface of the display and the base plate portion. The reinforcing member is provided in one or more spaces out of the plurality of spaces to reinforce the base plate portion. The one or more spaces are located at a position corresponding to the first coupling member.

### BRIEF DESCRIPTION OF THE DRAWINGS

FIG. 1 is a view illustrating a vehicle interior of a vehicle including a display device according to an embodiment;

FIG. 2 is a view illustrating the display device as viewed from a side;

FIG. 3 is an exploded schematic view of the display device as viewed from a side;

FIG. 4 is a view of a rear panel to which a connection plate is attached as viewed from a side of a second surface;

FIG. 5 is a view of the rear panel as viewed from a side of a first surface and a partially enlarged view;

FIG. 6 is a view illustrating the vehicle interior of the vehicle including the display device and a direction of an impact applied to the display device;

FIG. 7 is a view of a rear panel according to a first modification as viewed from the side of the first surface and a partially enlarged view;

FIG. 8 is a view of a rear panel according to a second modification as viewed from the side of the first surface;

FIG. 9 is a view of a rear panel according to a third modification as viewed from the side of the first surface;

FIG. 10 is a view of a rear panel according to a fourth modification as viewed from the side of the first surface;

FIG. 11 is a view illustrating one space and a reinforcing member according to a fifth modification as viewed from a direction perpendicular to the first surface;

FIG. 12 is a view illustrating one space and a reinforcing member according to a sixth modification as viewed from the direction perpendicular to the first surface;

FIG. 13 is a view of a rear panel according to a seventh modification as viewed from the side of the first surface;

FIG. 14 is a view of a rear panel according to an eighth modification as viewed from the side of the first surface;

FIG. 15 is a view of a rear panel according to a ninth modification as viewed from the side of the first surface;

FIG. 16 is a view of a rear panel according to a tenth modification as viewed from the side of the first surface; and

FIG. 17 is a view illustrating an example of a combination of materials.

### DETAILED DESCRIPTION

Hereinafter, an embodiment of a display device 20 according to the present disclosure will be described with reference to the drawings.

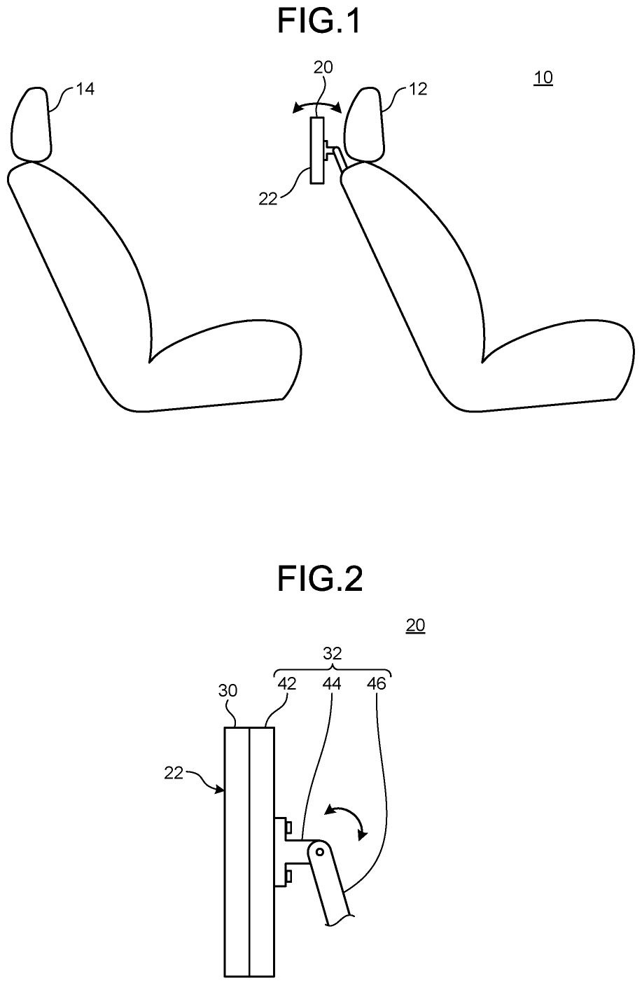

FIG. 1 is a view illustrating a vehicle interior of a vehicle 10 including the display device 20 according to an embodiment.

The vehicle 10 includes, for example, a front seat 12 and a rear seat 14. The display device 20 is attached to an upper end portion of the backrest of the front seat 12. The display device 20 is attach in a manner that a display surface 22 faces the rear seat 14. With this configuration, the display device 20 can provide an image to the passenger sitting on the rear seat 14.

In addition, the display device 20 is capable of changing the orientation of the display surface 22. For example, the display device 20 can rotate the display surface 22 in a perpendicular direction. Therefore, even when, for example, the angle of the backrest of the front seat 12 changes, the display device 20 can show the display surface 22 to the passenger sitting on the rear seat 14 at an appropriate angle.

The display device 20 may be attached to any place or component other than the front seat 12 in the vehicle interior of the vehicle 10.

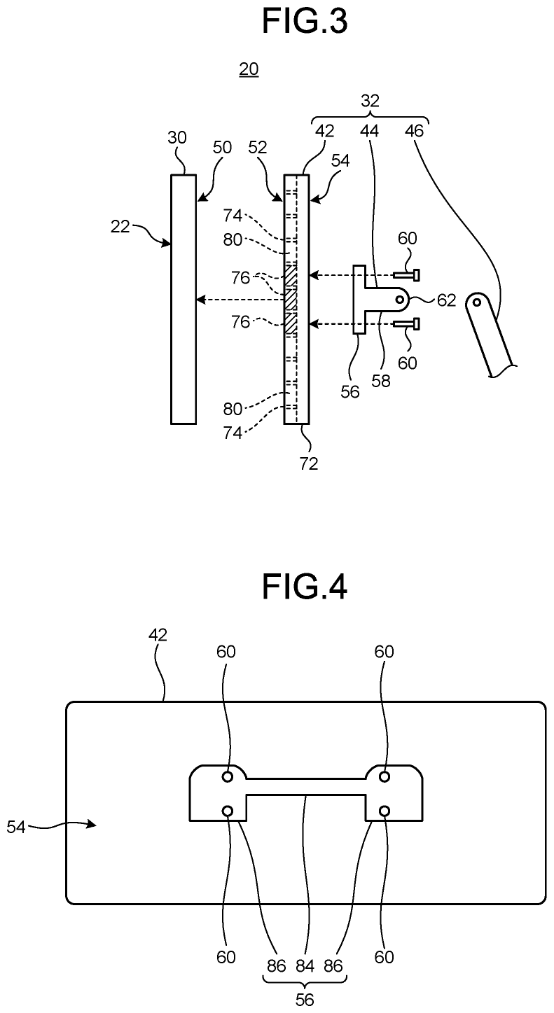

FIG. 2 is a view illustrating the display device 20 as viewed from a side. FIG. 3 is an exploded schematic view of the display device 20 as viewed from a side.

The display device 20 includes a display 30 and a support device 32. The support device 32 includes a rear panel 42, a first coupling member 44, and a second coupling member 46.

The display 30 has a substantially flat plate shape with a substantially rectangular plane. In the display 30, one plane serves as the display surface 22, and the other plane is a back surface 50. The display 30 displays images on the display surface 22.

The rear panel 42 has a substantially flat plate shape, and has a plane having substantially the same size and shape as the back surface 50 of the display 30. In the rear panel 42, a first surface 52 as the one plane is attached to the back surface 50 of the display 30 to support the display 30 from the back surface 50.

The first coupling member 44 is fixedly attached to a second surface 54 that is a surface of the rear panel 42 opposite to the first surface 52. The first coupling member 44 includes a connection plate 56 and an arm portion 58.

The connection plate 56 has a plate shape smaller than the second surface 54. The connection plate 56 is attached in contact with part of the second surface 54 of the rear panel 42. For example, the connection plate 56 is screwed to the rear panel 42 by a plurality of bolts 60. The arm portion 58 is provided on the connection plate 56. The arm portion 58 has, for example, a shape extending from the connection plate 56 in a direction perpendicular to the second surface 54. The connection plate 56 and the arm portion 58 may be formed integrally with one another.

The second coupling member 46 is provided to the first coupling member 44 so that the second coupling member 46 is able to rotate. The second coupling member 46 is attached to the first coupling member 44 via, for example, a shaft 62 parallel to the horizontal direction of the display surface 22 of the display 30. The second coupling member 46 with this configuration pivots on the shaft 62. In other words, the second coupling member 46 is rotatable with respect to the first coupling member 44 in a direction perpendicular to the display surface 22 of the display 30.

When no external force is applied to the first coupling member 44 and the second coupling member 46, the positional relationship between them is maintained by a lock mechanism of restricting frictional force or rotation. Therefore, when no external force is applied or when the lock mechanism is not released, the first coupling member 44 and the second coupling member 46 can fix the angle of the display surface 22 of the display 30. In addition, the first coupling member 44 and the second coupling member 46 change in positional relationship between them by rotation when a certain rotational force or more is applied from the outside or when the lock mechanism is released. With this configuration, the first coupling member 44 and the second coupling member 46 can change the angle of the display surface 22 of the display 30 when a certain rotational force or more is applied from the outside or when the lock mechanism is released.

The second coupling member 46 is attached to the front seat 12. Therefore, the display device 20 can be fixed to the front seat 12, and the display surface 22 of the display 30 can be presented to the passenger sitting on the rear seat 14.

Moreover, as illustrated in FIG. 3, the rear panel 42 includes a base plate portion 72, a plurality of ribs 74, and a reinforcing member 76. The base plate portion 72 has a flat plate shape and forms the second surface 54 of the rear panel 42.

The plurality of ribs 74 is provided on a surface of the base plate portion 72 corresponding to the first surface 52 of the rear panel 42. The ribs 74 each have a plate shape rising perpendicularly from the surface of the base plate portion 72 and have the same height from the surface of the base plate portion 72. The ribs 74 provide a plurality of spaces 80 between the back surface 50 of the display 30 and the base plate portion 72.

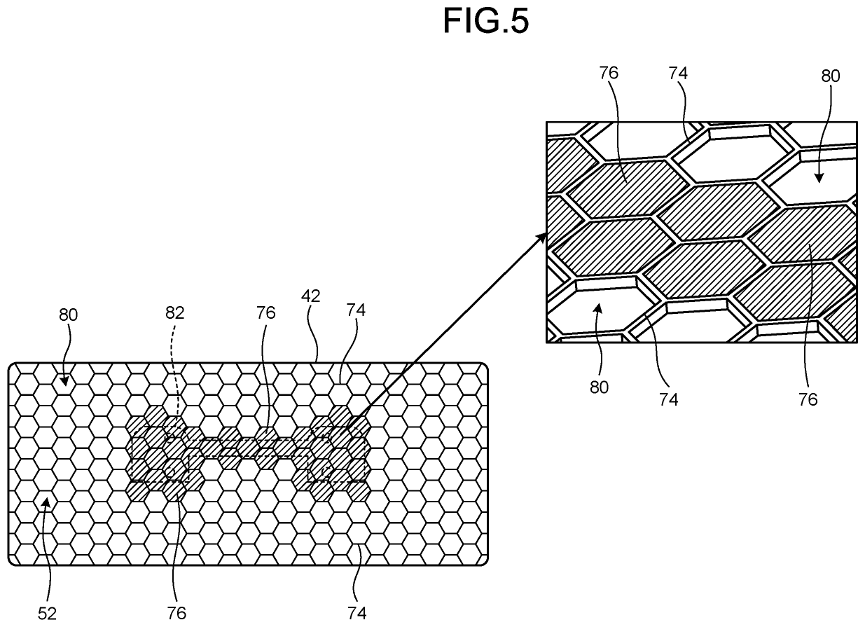

The reinforcing member 76 is provided in one or more spaces 80 located at a position corresponding to the first coupling member 44 out of the plurality of spaces 80 to reinforce the base plate portion 72. The ribs 74 and the reinforcing member 76 will be described in further detail with reference to FIG. 5 or the like.

FIG. 4 is a view of the rear panel 42 to which the connection plate 56 is attached as viewed from a side of the second surface 54. The connection plate 56 is screwed to the rear panel 42 by, for example, the plurality of bolts 60 substantially at the center of the second surface 54 of the rear panel 42.

The connection plate 56 includes, for example, a first member 84 extending in the horizontal direction of the display surface 22 of the display 30 and two second members 86 provided at both ends of the first member 84. The connection plate 56 as a whole is substantially H-shaped. The connection plate 56 is screwed to the rear panel 42 by the bolts 60 near the upper end and the lower end of each of the two second members 86 in the perpendicular direction. Note that the shape of the connection plate 56 is not limited to the shape illustrated in FIG. 4, and may be any shape.

FIG. 5 is a view of the rear panel 42 as viewed from the side of the first surface 52 and a partially enlarged view.

The plurality of ribs 74 is provided on a surface of the base plate portion 72 corresponding to the first surface 52 of the rear panel 42. Each of the ribs 74 has a plate shape perpendicularly rising from the surface of the base plate portion 72. In addition, each of the ribs 74 has the same height from the surface of the base plate portion 72. With this configuration, the plurality of ribs 74 can come into contact with the back surface 50 of the display 30 to support the display 30 from the back surface 50.

In addition, when the rear panel 42 is attached to the back surface 50 of the display 30, the plurality of ribs 74 provides the plurality of spaces 80 between the back surface 50 of the display 30 and the base plate portion 72. With this configuration, the plurality of ribs 74 can reduce the weight of the display device 20 as a whole.

The ribs 74 are disposed in a manner that, for example, the shape of the first surface 52 as viewed from the perpendicular direction has a honeycomb structure. Each of the spaces 80 created by the ribs 74 has a hexagonal shape having the same predetermined size when viewed from the perpendicular direction of the first surface 52. Therefore, the plurality of ribs 74 can support the display 30 while maintaining the strength by the honeycomb structure. As a result, the plurality of ribs 74 can efficiently support the display 30 with a small weight.

The reinforcing member 76 is provided in one or more spaces 80 at the position corresponding to the first coupling member 44 out of the plurality of spaces 80 provided by the plurality of ribs 74. For example, the reinforcing member 76 is provided in one or more spaces 80 in a connection region 82 corresponding to the connection plate 56 out of the plurality of spaces 80. In FIG. 5, the connection region 82 is indicated by a dotted line, and the reinforcing member 76 is hatched.

For example, as illustrated in FIG. 5, the reinforcing member 76 is provided in each of one or more spaces 80 in a region including the connection region 82 as a whole and having a shape and a size corresponding to the connection region 82. With this configuration, the reinforcing member 76 can improve the strength of the connection region 82 in the rear panel 42.

The reinforcing member 76 provided in each of one or more spaces 80 is formed to cover the whole or part of the portion where the surface of the base plate portion 72 is exposed in the corresponding space 80. With this configuration, the reinforcing member 76 can improve the strength of the portion of the corresponding space 80 in the base plate portion 72.

The reinforcing member 76 provided in each of one or more spaces 80 is formed by, for example, filling the inside of the corresponding space 80 as illustrated in the enlarged view in FIG. 5. The reinforcing member 76 filled in the space 80 has the same height from the surface of the base plate portion 72 as the plurality of ribs 74. With this configuration, the reinforcing member 76 can come into contact with the back surface 50 of the display 30 together with the plurality of ribs 74 to support the display 30 with high strength.

The base plate portion 72, the plurality of ribs 74, and the reinforcing member 76 may be formed of the same material. For example, the base plate portion 72, the plurality of ribs 74, and the reinforcing member 76 may be integrally formed by die casting or the like.

In addition, the base plate portion 72 and the plurality of ribs 74 may be made of the same material, and the reinforcing member 76 may be made of a material different from that of the base plate portion 72 and the plurality of ribs 74. In this case, the reinforcing member 76 is formed by, for example, injecting a material into the corresponding space 80 after the base plate portion 72 and the plurality of ribs 74 are integrally formed by die casting or the like.

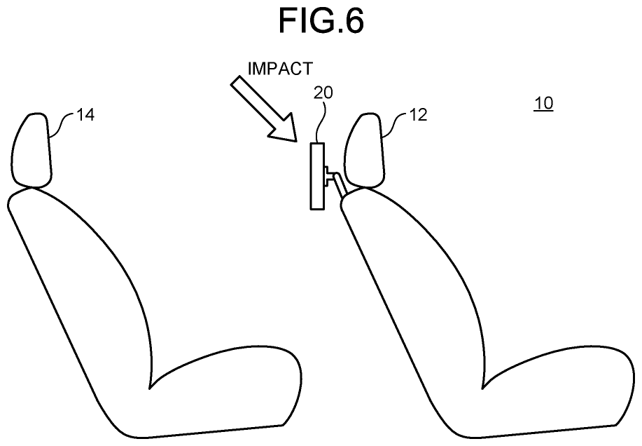

FIG. 6 is a view illustrating the vehicle interior of the vehicle 10 including the display device 20 and a direction of an impact applied to the display device 20.

For example, the display device 20 is attached above the front seat 12 in the vehicle interior of the vehicle 10. In this case, as illustrated in FIG. 6, there is a possibility that, for example, a large stress is applied to the connection portion between the rear panel 42 and the first coupling member 44 in the display device 20 due to impact from obliquely above the side of the rear seat 14 or the like. In order to confirm whether there is sufficient strength against such impact, a head impact test, in which an iron ball collides with the display device 20 from obliquely above the side of the rear seat 14, may be executed. In addition, not only in a case where the display device 20 is provided in the vehicle interior, but also in a case where a back surface portion of the display device 20 is connected to another component via a coupling member, there is a possibility that such impact is applied to the display device 20.

On the other hand, in the display device 20 according to the present embodiment, the rigidity of the connection portion between the rear panel 42 and the first coupling member 44 is improved by providing the reinforcing member 76 at the position corresponding to the first coupling member 44 in the rear panel 42. Accordingly, in the display device 20 according to the present embodiment, even when a large stress is applied to the connection portion between the rear panel 42 and the first coupling member 44, breakage or the like hardly occurs.

Moreover, in the display device 20 according to the present embodiment, the reinforcing member 76 is not provided in a region where stress is relatively less likely to be applied even by impact. Therefore, the display device 20 according to the present embodiment reduces the weight of a portion where breakage or the like is unlikely to occur.

As described above, the display device 20 according to the present embodiment can reduce the weight and improve the strength. Therefore, the display device 20 can efficiently support the display 30 with a small weight, in a manner that a load on a member to which the front seat 12 or the like is attached can be reduced.

Modification

Hereinafter, plural modifications of the display device 20 will be described. Each modification has substantially the same configuration and function as the display device 20 described with reference to FIGS. 1 to 6. Therefore, in each modification, differences from the display device 20 described with reference to FIGS. 1 to 6 will be mainly described.

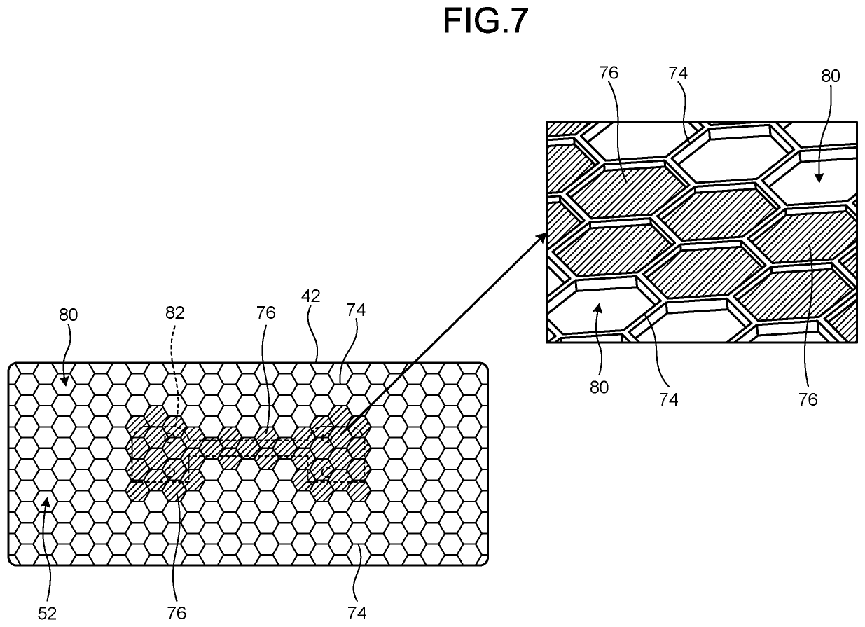

FIG. 7 is a view of the rear panel 42 according to a first modification as viewed from the side of the first surface 52 and a partially enlarged view.

For example, as illustrated in an enlarged view of FIG. 7, the reinforcing member 76 according to the first modification is formed by filling the inside of the corresponding space 80. Note that, in the reinforcing member 76 according to the first modification, the height from the surface of the base plate portion 72 is lower than the plurality of ribs 74. With this configuration, the reinforcing member 76 can provide a gap between the back surface 50 of the display 30 and the reinforcing member 76. Therefore, the display device 20 according to the first modification can reduce the weight while maintaining sufficient rigidity at the connection portion between the display 30 and the rear panel 42. The height of the reinforcing member 76 from the surface of the base plate portion 72 according to the first modification is, for example, half or more of the height of the plurality of ribs 74 from the surface of the base plate portion 72.

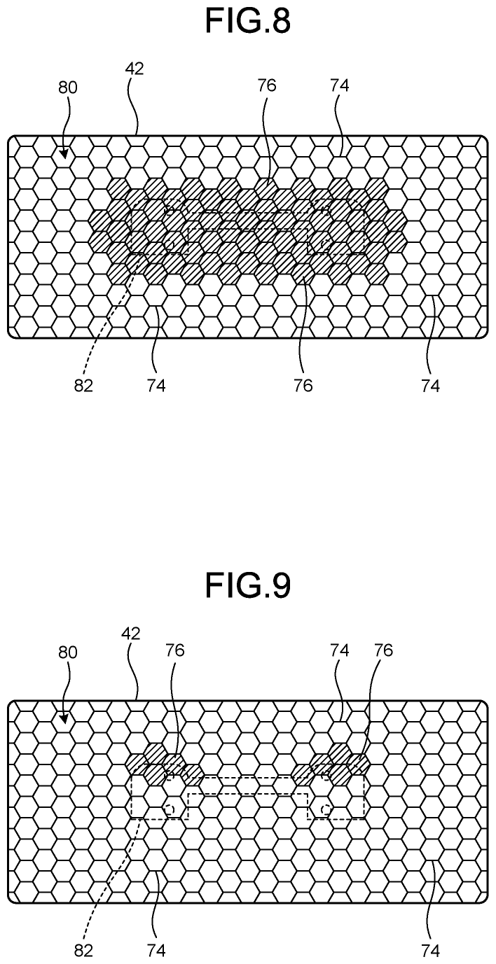

FIG. 8 is a view of the rear panel 42 according to a second modification as viewed from the side of the first surface 52.

In the second modification, the reinforcing member 76 is provided in each of one or more spaces 80 located in a region that includes the connection region 82 as a whole and that is wider than the connection region 82. For example, the region where the reinforcing member 76 is provided is a region including the whole connection region 82 and having a predetermined shape such as a rectangle. With this configuration, the display device 20 according to the second modification can make breakage or the like less likely to occur even when stress due to impact is applied to a region wider than the connection region 82. In addition, in the display device 20 according to the second modification, even when the shape of the first coupling member 44 is changed or the attaching position of the first coupling member 44 with respect to the rear panel 42 is changed due to, for example, a design change, it is not necessary to change the position where the reinforcing member 76 is provided in the rear panel 42.

FIG. 9 is a view of the rear panel 42 according to a third modification as viewed from the side of the first surface 52.

In the third modification, the reinforcing member 76 is provided in each of one or more spaces 80 in the upper edge portion corresponding to the upper side of the display 30 in the perpendicular direction in the connection region 82. With this configuration, the display device 20 according to the third modification can make breakage or the like less likely to occur in a portion to which strong stress is applied by an impact from obliquely above the rear seat 14 side or the like. In addition, the display device 20 according to the third modification can reduce the region where the reinforcing member 76 is provided. Therefore, the display device 20 according to the first modification can reduce the weight while maintaining sufficient rigidity at the connection portion between the display 30 and the rear panel 42.

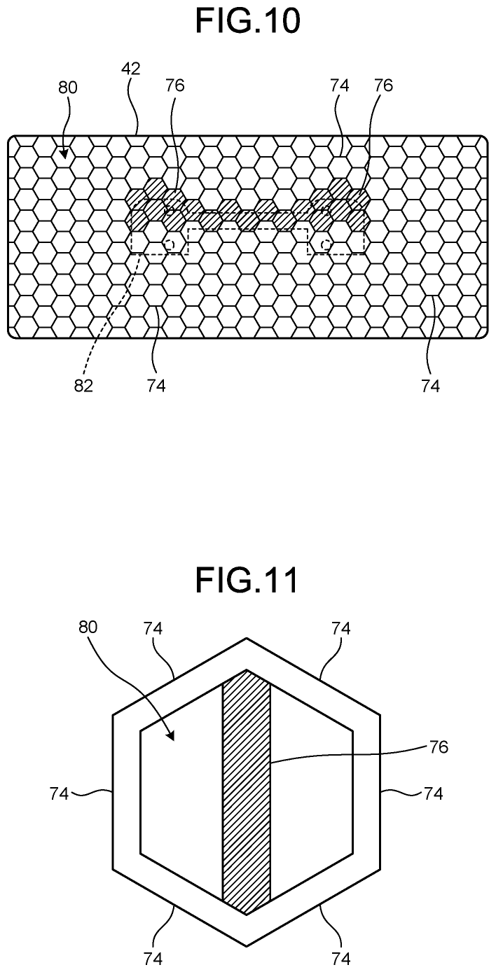

FIG. 10 is a view of the rear panel 42 according to a fourth modification as viewed from the side of the first surface 52.

In the fourth modification, the reinforcing member 76 is provided in each of one or more spaces 80 in a substantially half region corresponding to the upper side of the display 30 in the connection region 82. With this configuration, the display device 20 according to the fourth modification can make breakage or the like less likely to occur in a portion to which the strongest stress is applied by an impact from obliquely above the rear seat 14 side or the like and around the portion. In addition, the display device 20 according to the fourth modification can reduce a region where the reinforcing member 76 is provided, so that the display device 20 can reduce the weight while maintaining sufficient rigidity at the connection portion between the display 30 and the rear panel 42.

FIG. 11 is a view illustrating one space 80 created by the ribs 74 and the reinforcing member 76 according to a fifth modification as viewed from a direction perpendicular to the first surface 52.

The reinforcing member 76 according to the fifth modification is a single plate which perpendicularly rises from the surface of the base plate portion 72 inside the corresponding space 80. The reinforcing member 76 according to the fifth modification is formed to have a linear shape as viewed from the direction perpendicular to the first surface 52 inside the corresponding space 80. When the corresponding space 80 is a hexagon as viewed from the perpendicular direction of the first surface 52, the plate-shaped reinforcing member 76 is a straight line connecting one vertex of the hexagon and a vertex of a symmetrical position across the center of the hexagon. Alternatively, the plate-shaped reinforcing member 76 may have a linear shape connecting one side of the hexagon and a side at a symmetrical position across the center of the hexagon. The reinforcing member 76 may be a linear member extending in the vertical direction when viewed from the direction perpendicular to the first surface 52. When an impact is received from obliquely above the side of the rear seat 14 or the like, a strong stress is applied in the vertical direction of the display device 20 as viewed from the direction perpendicular to the first surface 52. By forming the reinforcing member 76 as a member extending in a direction in which a strong stress is applied, rigidity can be maintained by the connection portion between the display 30 and the rear panel 42.

The reinforcing member 76 having such a configuration has a gap in part of the inside of the corresponding space 80. Therefore, it is possible to reduce the weight while maintaining the rigidity of the corresponding portion of the rear panel 42. In the reinforcing member 76 according to the fifth modification, the height from the surface of the base plate portion 72 may be equal to or lower than the plurality of ribs 74.

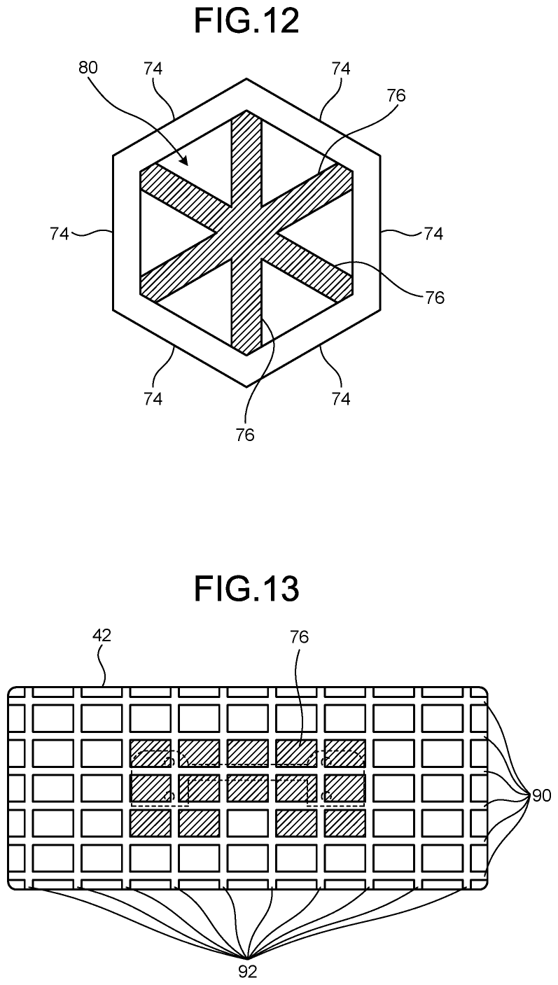

FIG. 12 is a view illustrating one space 80 created by the ribs 74 and the reinforcing member 76 according to a sixth modification as viewed from a direction perpendicular to the first surface 52.

The reinforcing member 76 according to the sixth modification is a single plate which perpendicularly rises from the surface of the base plate portion 72 inside the corresponding space 80. The plate-shaped reinforcing member 76 is formed to have a radial shape extending outward from the center of the corresponding space 80 when viewed from the perpendicular direction of the first surface 52 inside the corresponding space 80. When the corresponding space 80 is hexagonal as viewed from the perpendicular direction of the first surface 52, the reinforcing member 76 may be six plates extending linearly from the center of the hexagon to each of the six vertices of the hexagon. In addition, the reinforcing member 76 may be three, four, or five plates extending linearly from the center of the hexagon to each of three, four, or five vertices of the six vertices.

Alternatively, the reinforcing member 76 may be six plates extending linearly from the center of the hexagon to each of the six sides of the hexagon. In addition, the reinforcing member 76 may be three, four, or five plates extending linearly from the center of the hexagon to each of three, four, or five sides of the six sides.

The reinforcing member 76 having such a configuration has a gap in part of the inside of the corresponding space 80. Therefore, it is possible to reduce the weight while maintaining the rigidity of the corresponding portion of the rear panel 42. In the reinforcing member 76 according to the sixth modification, the height from the surface of the base plate portion 72 may be equal to or lower than the plurality of ribs 74.

FIG. 13 is a view of the rear panel 42 according to a seventh modification as viewed from the side of the first surface 52. Each of spaces 80 according to the seventh modification has a quadrangular shape when viewed from the perpendicular direction of the first surface 52.

The plurality of ribs 74 according to the seventh modification includes lateral ribs 90 and longitudinal ribs 92. Each of the lateral ribs 90 extends in the horizontal direction of the display surface 22 of the display 30. In addition, the lateral ribs 90 are arranged in parallel at predetermined intervals. Each of the longitudinal ribs 92 extends in the perpendicular direction of the display surface 22 of the display 30. In addition, the longitudinal ribs 92 are arranged in parallel at predetermined intervals. Such lateral ribs 90 and longitudinal ribs 92 can provide spaces 80 each having a quadrangular shape when viewed from the perpendicular direction of the first surface 52.

The reinforcing member 76 according to the seventh modification is provided in the space 80 located at the position corresponding to the first coupling member 44 out of the plurality of spaces 80 to reinforce the base plate portion 72. For example, the reinforcing member 76 may be formed to entirely cover the bottom surface of the space 80 as illustrated in FIG. 5 or 7, or may be formed to provide a gap in part of the bottom surface of the space 80 as illustrated in FIGS. 11 and 12.

FIG. 14 is a view of the rear panel 42 according to an eighth modification as viewed from the side of the first surface 52. Each of spaces 80 according to the eighth modification has a rhombus shape when viewed from the perpendicular direction of the first surface 52.

The plurality of ribs 74 according to the eighth modification includes first inclined ribs 94 and second inclined ribs 96. Each of the first inclined ribs 94 extends at a predetermined angle larger than 0° and smaller than 90° with respect to the horizontal direction of the display surface 22 of the display 30. In addition, the first inclined ribs 94 are arranged in parallel at predetermined intervals. Each of the second inclined ribs 96 extends at a predetermined angle smaller than 0° and larger than −90° with respect to the horizontal direction of the display surface 22 of the display 30. In addition, the second inclined ribs 96 are arranged in parallel at predetermined intervals. Similarly to the seventh modification, the first inclined ribs 94 and the second inclined ribs 96 can provide the spaces 80 each having a quadrangular shape when viewed from the perpendicular direction of the first surface 52.

In addition, similarly to the seventh modification, the reinforcing member 76 according to the eighth modification is provided in one or more spaces 80 at the position corresponding to the first coupling member 44 out of the plurality of spaces 80 to reinforce the base plate portion 72. Then, the reinforcing member 76 may be formed to entirely cover the bottom surface of the space 80 as illustrated in FIG. 5 or 7, or may be formed to form a gap in part of the bottom surface of the space 80 as illustrated in FIGS. 11 and 12.

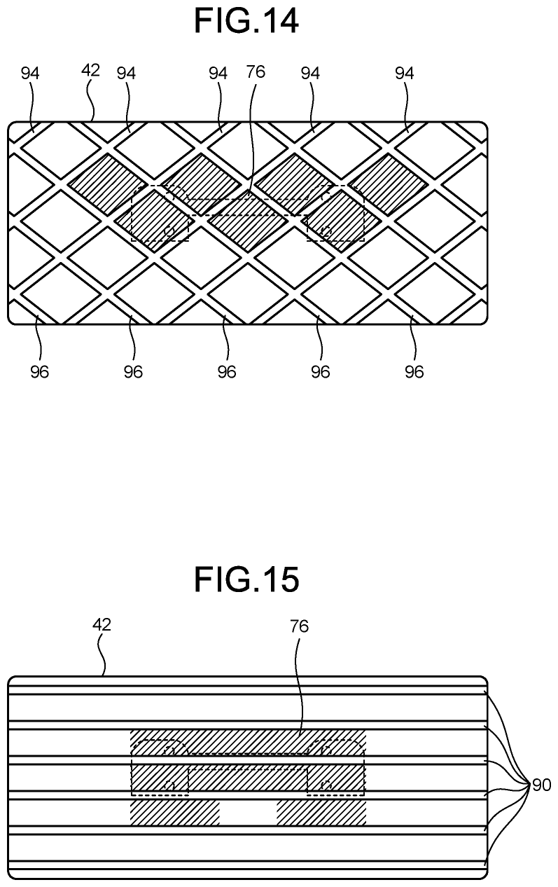

FIG. 15 is a view of the rear panel 42 according to a ninth modification as viewed from the side of the first surface 52.

The plurality of ribs 74 according to the ninth modification includes the lateral ribs 90 described in the seventh modification. In this case, the reinforcing member 76 is formed in a partial region of the connection region 82 or a region including the connection region 82 as a whole. For example, the reinforcing member 76 according to the ninth modification may be formed to entirely cover the bottom surface of the space 80 as illustrated in FIG. 5 or 7, or may be formed to form a gap in part of the bottom surface of the space 80 as illustrated in FIGS. 11 and 12.

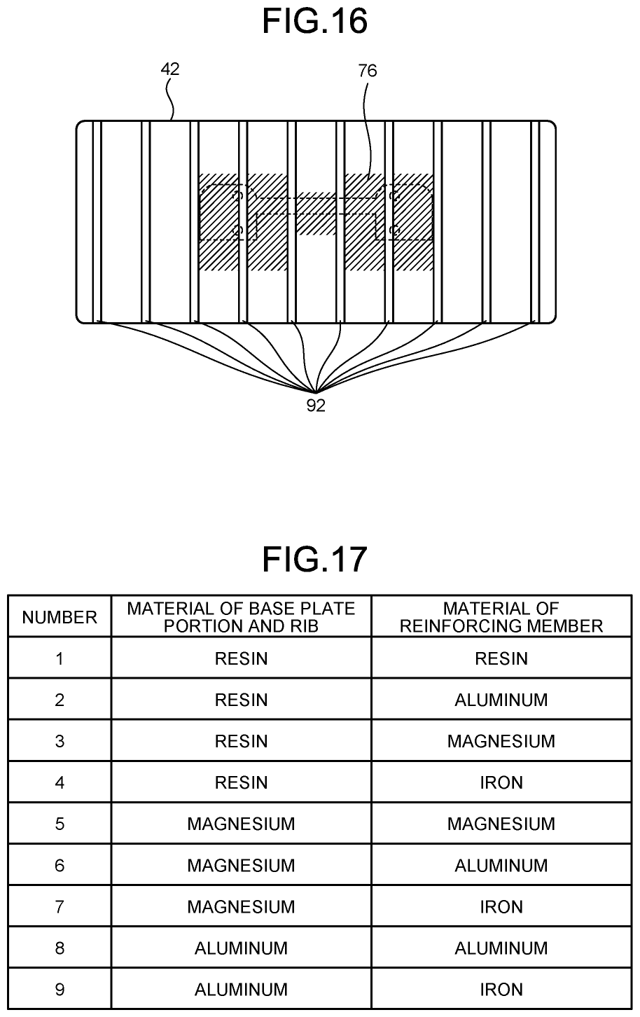

FIG. 16 is a view of the rear panel 42 according to a tenth modification as viewed from the side of the first surface 52.

The plurality of ribs 74 according to the tenth modification includes the longitudinal ribs 92 described in the seventh modification. In this case, the reinforcing member 76 is formed in a partial region of the connection region 82 or a region including the whole connection region 82. For example, the reinforcing member 76 according to the tenth modification may be formed to entirely cover the bottom surface of the space 80 as illustrated in FIG. 5 or 7, or may be formed to form a gap in part of the bottom surface of the space 80 as illustrated in FIGS. 11 and 12.

The plurality of ribs 74 according to the tenth modification may include only the first inclined ribs 94 or may include only the second inclined ribs 96 described in the eighth modification, for example.

FIG. 17 is a view illustrating an example of a combination of materials.

In the present embodiment, the base plate portion 72 and the plurality of ribs 74 in the rear panel 42 are formed of the same material. As an example, the base plate portion 72 and the plurality of ribs 74 are formed of resin, magnesium, or aluminum.

In addition, the reinforcing member 76 in the rear panel 42 may be formed of the same material as the base plate portion 72 and the plurality of ribs 74. For example, all of the base plate portion 72, the plurality of ribs 74, and the reinforcing member 76 may be formed of resin, magnesium, or aluminum.

In addition, the reinforcing member 76 in the rear panel 42 may be formed of a material different from that of the base plate portion 72 and the plurality of ribs 74. In this case, the reinforcing member 76 is formed of a material having higher rigidity than the base plate portion 72 and the plurality of ribs 74.

For example, in a case where the base plate portion 72 and the plurality of ribs 74 are formed of resin, the reinforcing member 76 may be formed of aluminum, magnesium, or iron. In addition, for example, in a case where the base plate portion 72 and the plurality of ribs 74 are formed of magnesium, the reinforcing member 76 may be formed of aluminum or iron. In addition, for example, in a case where the base plate portion 72 and the plurality of ribs 74 are formed of aluminum, the reinforcing member 76 may be formed of iron.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

According to the support device and the display device of the present disclosure, weight can be reduced and rigidity can be improved.

What is claimed is:

1. A support device comprising:
a rear panel including a first surface attached to a back surface of a display to support the display from the back surface; and
a first coupling member fixedly attached to a second surface of the rear panel opposite to the first surface, wherein
the rear panel includes
a base plate portion having a flat plate shape,
a plurality of ribs provided on a surface of the base plate portion corresponding to the first surface of the rear panel, each rib having a plate shape perpendicularly rising from a surface of the base plate portion and having a same height from the surface of the base plate portion, the plurality of ribs being configured to provide a plurality of spaces between the back surface of the display and the base plate portion, and
a reinforcing member provided in one or more spaces out of the plurality of spaces to reinforce the base plate portion, the one or more spaces being located at a position corresponding to the first coupling member.

2. The support device according to claim 1, further comprising a second coupling member provided to the first coupling member such that the second coupling member is allowed to rotate.

3. The support device according to claim 1, wherein
the first coupling member includes
a connection plate that is plate-shaped and attached in contact with the rear panel, and
an arm portion provided on the connection plate, and
the reinforcing member is provided in one or more spaces out of the plurality of spaces, the one or more spaces being located in a connection region corresponding to the connection plate.

4. The support device according to claim 3, wherein the reinforcing member is provided in each of one or more spaces located in an upper edge portion in the connection region, the upper edge portion corresponding to an upper side of the display.

5. The support device according to claim 3, wherein the reinforcing member is provided in each of one or more spaces located in a region including the connection region as a whole, the region having a shape and a size corresponding to the connection region.

6. The support device according to claim 3, wherein the reinforcing member is provided in each of one or more spaces located in a region including the connection region as a whole.

7. The support device according to claim 1, wherein each spaces in the plurality of spaces has a hexagonal shape with a predetermined size when viewed from a direction perpendicular to the first surface.

8. The support device according to claim 1, wherein each spaces in the plurality of spaces has a quadrangular shape when viewed from a direction perpendicular to the first surface.

9. The support device according to claim 1, wherein the reinforcing member covers an entire surface of the base plate portion in the corresponding space.

10. The support device according to claim 1, wherein the reinforcing member is a single plate perpendicularly rising from the base plate portion, the reinforcing member having a linear shape as viewed from the direction perpendicular to the first surface inside the corresponding space.

11. The support device according to claim 1, wherein the reinforcing member is a plurality of plates perpendicularly rising from the base plate portion, the reinforcing member having a radial shape extending outward from a center of the corresponding space when viewed from the direction perpendicular to the first surface inside the corresponding space.

12. The support device according to claim 1, wherein a height of the reinforcing member from the surface of the base plate portion is equal to the height of the plurality of ribs.

13. The support device according to claim 1, wherein a height of the reinforcing member from the surface of the base plate portion is lower than the height of the plurality of ribs.

14. The support device according to claim 1, wherein a material of the reinforcing member is the same as a material of the plurality of ribs.

15. The support device according to claim 1, wherein the reinforcing member has higher rigidity than the plurality of ribs.

16. A display device comprising:
a display; and
a support device supporting the display, wherein
the support device includes
a rear panel including a first surface attached to a back surface of a display to support the display from the back surface, and
a first coupling member fixedly attached to a second surface of the rear panel opposite to the first surface, and
the rear panel includes
a base plate portion having a flat plate shape,
a plurality of ribs provided on a surface of the base plate portion corresponding to the first surface of the rear panel, each rib having a plate shape perpendicularly rising from a surface of the base plate portion and having a same height from the surface of the base plate portion, the plurality of ribs being configured to provide a plurality of spaces between the back surface of the display and the base plate portion, and
a reinforcing member provided in one or more spaces out of the plurality of spaces to reinforce the base plate portion, the one or more spaces being located at a position corresponding to the first coupling member.
